(19) United States
(12) Patent Application Publication
(10) Pub. No.: US 2022/0214433 A1
(43) Pub. Date: Jul. 7, 2022

(54) TIME-OF-FLIGHT DEVICE AND METHOD

(71) Applicant: Sony Semiconductor Solutions Corporation, Kanagawa (JP)

(72) Inventor: Michiel Timmermans, Stuttgart (DE)

(73) Assignee: Sony Semiconductor Solutions Corporation, Kanagawa (JP)

(21) Appl. No.: 17/607,463

(22) PCT Filed: Apr. 30, 2020
(86) PCT No.: PCT/EP2020/062035

§ 371 Date: Oct. 29, 2021

(30) Foreign Application Priority Data
May 6, 2019 (EP) 19172765.0

(51) Int. Cl. G01S 7/4863; G01S 7/4865; G01S 17/32

(52) U.S. Cl. CPC G01S 7/4863; G01S 17/32; G01S 7/4865

(57) ABSTRACT

The present disclosure pertains to a time-of-flight device with a light detection portion including at least one photo conversion portion and a first biasing voltage portion and a second biasing voltage portion adjacent to the at least one photo conversion portion for generating an electric field across the at least one photo conversion portion.

### TECHNICAL FIELD

The present disclosure generally pertains to a time-of-flight device and a method for controlling a time-of-flight device.

### TECHNICAL BACKGROUND

Known time-of-flight systems typically have a light source for illuminating a region of interest (e.g. object, scene or the like) and a sensor for detecting light stemming from the region of interest for determining a distance between the light source and the region of interest.

The distance can be determined, for example, based on the time-of-flight of the photons emitted by the light source and reflected in the region of interest, which, in turn, is associated with the distance.

This technology is also referred to as direct time-of-flight (dToF) and it can be based, for example, on determining a roundtrip time of the light when travelling from the light source to the region of interest and back to the sensor.

Moreover, an indirect time-of-flight device (iToF) is known, which indirectly obtains distance measurements by detecting a phase shift of the detected light, which is reflected from the scene. For iToF it is known to emit, e.g. continuously, modulated light to the scene and to demodulate the reflected light and to determine the phase shift, which, in turn, is proportional to the distance.

Generally, for iToF several sensor technologies are known, e.g. gated sensors, current assisted sensors, etc.

Although there exists time-of-flight sensors and methods for controlling them, it is generally desirable to provide a time-of-flight device and a method for controlling a time-of-flight device, which enhance the detection of light reflected from a scene.

### SUMMARY

According to a first aspect, the disclosure provides a time-of-flight device comprising: a light detection portion including at least one photo conversion portion and a first biasing voltage portion and a second biasing voltage portion adjacent to the at least one photo conversion portion for generating an electric field across the at least one photo conversion portion.

According to a second aspect, the disclosure provides a method for controlling a time-of-flight device including a light detection portion including at least one photo conversion portion and a first biasing voltage portion and a second biasing voltage portion adjacent to the at least one photo conversion portion for generating an electric field across the at least one photo conversion portion, the method comprising applying the biasing voltage by applying a voltage to the first and the second biasing voltage portions.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically illustrates an embodiment of a time-of-flight device;

FIG. 2 illustrates an embodiment of a light detection portion;

FIG. 3 illustrates a timing diagram of operating the light detection portion;

FIG. 4 illustrates a pixel of the light detection portion and a cut-line through the pixel;

FIG. 5 illustrates an energy level in the pixel of FIG. 4 along the cut-line illustrated in FIG. 4;

FIG. 6 schematically shows two cross-sections through a pixel of the light detection portion;

FIG. 7 illustrates another embodiment of a light detection portion;

FIG. 8 illustrates another embodiment of a light detection portion;

FIG. 9 illustrates another embodiment of a light detection portion;

FIG. 10 illustrates an embodiment of a light detection portion, wherein four transfer gates are provided at each pixel;

FIG. 11 is a flowchart of a method for controlling a time-of-flight device;

FIG. 12 illustrates a variant of the embodiment of a light detection portion of FIG. 8; and

FIG. 13 illustrates a timing diagram of operating the light detection portion of FIG. 12.

### DETAILED DESCRIPTION OF EMBODIMENTS

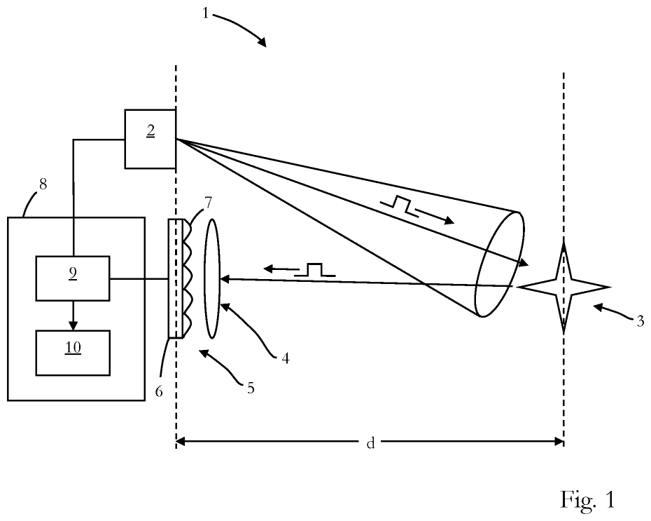

Before a detailed description of the embodiments under reference of FIG. 1 is given, general explanations are made.

As mentioned in the outset, generally, different time-of-flight (ToF) technologies are known, such as direct time-of-flight (dToF) and indirect time-of-flight device (iToF), which indirectly obtains distance measurements by detecting a phase shift of the detected light, which is reflected from the scene.

Hence, some embodiments, generally pertain to iToF and it has been recognized that in some embodiments a light detection and demodulation may be improved by generating an electric field and applying it to an iToF sensor, as will also be discussed further below, for enhancing a charge carrier transport in the sensor.

Consequently, some embodiments pertain to a time-of-flight device including a light detection portion including at least one photo conversion portion and a first biasing voltage portion and a second biasing voltage portion adjacent to the at least one photo conversion portion for generating an electric field across the at least one photo conversion portion.

As discussed, in some embodiments, the time-of-flight device pertains to iToF and, thus, e.g. it determines a distance based on detecting a phase shift of emitted modulated light which is reflected from a scene and detected by the light detection portion, as it is generally known for iToF.

Generally, the light detection portion may be based on any kind of light detection technology, but in some embodiments it is based on an iToF light detection technology, and, thus, the at least one photo conversion portion may be based on a semiconductor structure, which is able to convert photons into positive and negative charge carriers. The charge carriers are accumulated, e.g. in a capacitor or the like. For demodulation of the detected light, in some embodiments, the at least one photo conversion portion may be implemented as a current assisted photonic demodulator (CAPD). In other embodiments, the at least one photo conversion portion may be implemented as a current assisted gated photo conversion portion, also referred to as current assisted gated iToF (CAG iToF).

In some embodiments, the photonic demodulation is performed by providing at least two demodulation portions (e.g. gates or the like) which are provided in or at the photo conversion portions, wherein the charge carriers travel to the two demodulation portions which are driven such that the electric charge carriers/charges are discharged or accumulated, e.g. to or in a capacitor or other storage portion which is adapted to store electric carriers/charges. The demodulation portions may driven with a phase difference, for instance, 180° (without limiting the present disclosure in that regard; the phase difference may also depend on the number of gates provided in some embodiments, e.g. for four gates the phase difference may be each 90°).

As mentioned, the light detection portion has at least a first biasing voltage portion and a second biasing voltage portion adjacent to the at least one photo conversion portion. The first and the second biasing voltage portions may be formed by providing a predetermined doping at the portion in a semiconductor substrate, by providing a respective conductive material, etc. The first and the second biasing voltage portions can be applied with a corresponding biasing voltage, such that an electric field can be generated across the photo conversion portion, whereby the charge carrier transport may be enhanced.

In some embodiments, the at least one photo conversion portion includes a first transfer gate and a second transfer gate. For instance, in gated iToF, the region that is modulated by the two transfer gates may not be very large. In cases, where a photo conversion portion (e.g. pixel area) is large, this may lead to a lower modulation contrast, which is, in some embodiments, a metric for the ability of a pixel (photo conversion portion) to demodulate a reflected light signal to a reference signal, as it is known for iToF. By applying the electric field, the modulation contrast may be enhance in some embodiments.

By providing the first and the second biasing voltage portions, a biasing voltage can be applied to the first and the second biasing voltage portions, such that thereby the electric field can be generated, e.g. having a gradient such that the charge carrier transport to a currently active transfer gate may be enhanced.

The delivery of the signal to the first and second biasing voltage portions can be implemented in different ways. For instance, in some embodiments, separate (extra) routing signals are provided, in others a transfer gate signal is applied directly to the first and second biasing voltage portions, in still other embodiments, the transfer gate signal(s) may be used to switch a switch that connects the first/second biasing voltage portions to a separate bias voltage.

In some embodiments, the photo conversion portion has a pinning layer and a sidewall and by applying biasing voltages to the first and second biasing voltage portions, the pinning layer and sidewalls of the photo conversion portions may be pulled up in the electric potential domain (which means a low electric energy, and vice versa), such that the charge carrier transport may be enhanced, since charges flow to a low energy region i.e. a high potential region. Moreover, when the photo conversion portion is floating, its potential may follow the potential of the pinning layer. Since the pinning layer is pulled up to a different potential at both sides of the photo conversion portion in some embodiments, by applying a high biasing voltage to the first biasing voltage portion and a low biasing voltage to the second biasing voltage portion (and vice versa), an electric field or electric potential gradient exists which will be reflected inside the photo conversion potential and generates an electric field.

In some embodiments, the electric field applied to the first and second biasing voltage portions is aligned with the first gate and the second gate, e.g. the electric field lines are basically in a direction (aligned to this direction) from the first transfer gate to the second transfer gate (or vice versa).

In some embodiments, the electric field is such applied that electric charge carriers which are generated by photons incident into the at least one photo conversion portion are directed to the first gate and second gate, respectively, as is also apparent from the discussion above.

In some embodiments, the light detection portion includes multiple photo conversion portions, which are arranged in an array. The multiple light detection portions may be configured as pixels.

In some embodiments, the first and the second biasing voltage portions are each located between adjacent photo conversion portions, such that the biasing voltage portions are on a middle line which intersects the photo conversion portions arranged on a line in a middle area. For instance, in an array, where the photo conversion portions are arranged in rows and columns, the first and second biasing voltage portions are arranged in a row (column) of a row (column) of photo conversion portions, wherein the first and second biasing voltage portions are located on a line which intersects the photo conversion portions in a row (column) each in a middle area.

In some embodiments, the first and the second biasing voltage portions are each arranged adjacent to four photo conversion portions. For example, the first and second biasing voltage portions are each arranged in a middle area between four corners of four adjacent photo conversion portions.

In such embodiments, a third and a fourth transfer gate may be provided, such that each of the photo conversion portions may have four transfer gates (a first, second, third and fourth), which are located at four corner areas of the photo-conversion portions (and which may surround a common region).

In some embodiments, the multiple conversion portions are such arranged that first transfer gates of four photo conversion portions are located next to each other, second gates of four photo conversion portions are located next to each other, third transfer gates of four photo conversion portion are located next to each other and fourth transfer gates of four photo conversion portions are located next to each other. Thereby, the first and second biasing voltage portions can be arranged in a middle area of the first/second/third/fourth transfer gates which are located next to each other (i.e. in the center of a common region which is surrounded by the first transfer gates, the second transfer gates, the third transfer gates or the fourth transfer gates).

As mentioned, in some embodiments, the at least one photo conversion portion is configured as a current assisted photonic demodulator.

As discussed above, in some embodiments, the first (second, third, fourth) biasing voltage portion and the first (second, third, fourth) transfer gate are associated to each other. Hence, in some embodiments, the first (second, third, fourth, etc.) transfer gates of different neighboring photo conversion portions (e.g. pixels) are such arranged that they may share a common first (second, third, fourth, etc.) biasing voltage portion.

Some embodiments pertain to a method for controlling a time-of-flight device including a light detection portion including at least one photo conversion portion and a first biasing voltage portion and a second biasing voltage portion adjacent to the at least one photo conversion portion for generating an electric field across the at least one photo conversion portion, as discussed above, wherein the method includes applying the biasing voltage by applying a voltage to the first and the second biasing voltage portions, as also discussed above.

As mentioned above, applying the biasing voltage may include application of a high biasing voltage to the first biasing voltage portion and a low biasing voltage to the second biasing voltage portion, and vice versa. This may also be performed alternately, such that the first biasing voltage portion may be supplied alternately with a high and a low biasing voltage and the second biasing voltage portion may be supplied alternately with a low and a high biasing voltage.

In some embodiments, as discussed, the at least one photo conversion portion includes a first transfer gate and a second transfer gate and the method further includes controlling the first and the second transfer gate consecutively for performing demodulation of a detected light signal (e.g. having a phase shift of 180° without limiting the present disclosure in that regard). Moreover, the application of the biasing voltage may be synchronized with the driving of the first and the second transfer gates, as discussed above, such that, for instance, when the first gate is driven (open), the first biasing voltage portion is supplied with a high biasing voltage and the second biasing voltage portion is supplied with a low biasing voltage and when the second transfer gate is driven, the first biasing voltage portion is supplied with a low biasing voltage and the second biasing voltage portion is supplied with a high biasing voltage.

In some embodiments, as discussed, the first and the second biasing voltage portions are each located between adjacent photo conversion portions, such that the biasing voltage portions are on a middle line which intersects the photo conversion portions arranged on a line in a middle area, wherein the application of the biasing voltage is adapted to driving of transfer gates of the two neighboring photo conversion portions.

In some embodiments, the first and second biasing voltage portions are located on a line, which is not in the middle of the pixel, but which is located, for example, a small amount shifted away from the middle, in order to be closer to the transfer gates.

In some embodiments, as discussed, the first and the second biasing voltage portions are each arranged adjacent to four photo conversion portions and the application of the biasing voltage is adapted to driving of transfer gates of the four neighboring photo conversion portions.

In some embodiments, as discussed, the multiple conversion portions are such arranged that first transfer gates of four photo conversion portions are located next to each other, second gates of four photo conversion portions are located next to each other, third transfer gates of four photo conversion portion are located next to each other and fourth transfer gates of four photo conversion portions are located next to each other, wherein the application of the biasing voltage is adapted to driving of the first to fourth transfer gates of the four neighboring photo conversion portions.

Moreover, in some embodiments, the first and second biasing voltage portions may be activated (only) when high performance (e.g. high modulation frequency or high demodulation contrast) is needed and/or in other in certain applications or conditions. Thereby, in some embodiments, an increase of power consumption for applying the extra electric field may not be required in all instances.

Returning to FIG. 1, there is illustrated an embodiment of a time-of-flight (ToF) device 1, which can be used for depth sensing or providing a distance measurement, in particular for the technology as discussed herein. The ToF device 1 has a circuitry 8 which is configured to perform the methods as discussed herein (and which will be discussed further below) and which forms a control of the ToF device 1 (and it includes, not shown, corresponding processors, memory and storage as it is generally known to the skilled person).

The ToF device 1 has a light source 2 configured to emit modulated light and it includes light emitting elements (based on laser diodes), wherein in the present embodiment, the light emitting elements are narrow band laser elements.

The light source 2 emits modulated light to a scene 3 (region of interest or object), which reflects the light. By repeatedly emitting light to the scene 3, the scene 3 can be scanned, as it is generally known to the skilled person. The reflected light is focused by an optical stack 4 to a light detector 5.

The light detector 5 has an image sensor 6, which is implemented based on multiple CAGs (current assisted gated photo conversion) pixels formed in an array of pixels and a microlens array 7 which focuses the light reflected from the scene 3 to the image sensor 6 (to each pixel of the image sensor 6).

The light emission time and modulation information is fed to the circuitry or control 8 including a time-of-flight measurement unit 9, which also receives respective information from the image sensor 6, when the light is detected which is reflected from the scene 3. The modulated light is demodulated by the image sensor 6, whereby the time-of-flight measurement unit 9 computes a phase shift of the received modulated which has been emitted from the light source 2 and reflected by the scene 3 and on the basis thereon it computes a distance d (depth information) between the image sensor 6 and the scene 3, as also discussed above.

The depth information is fed from the time-of-flight measurement unit 9 to a 3D image reconstruction unit 10 of the circuitry 8, which reconstructs (generates) a 3D image of the scene 3 based on the depth information received from the time-of-flight measurement unit 9.

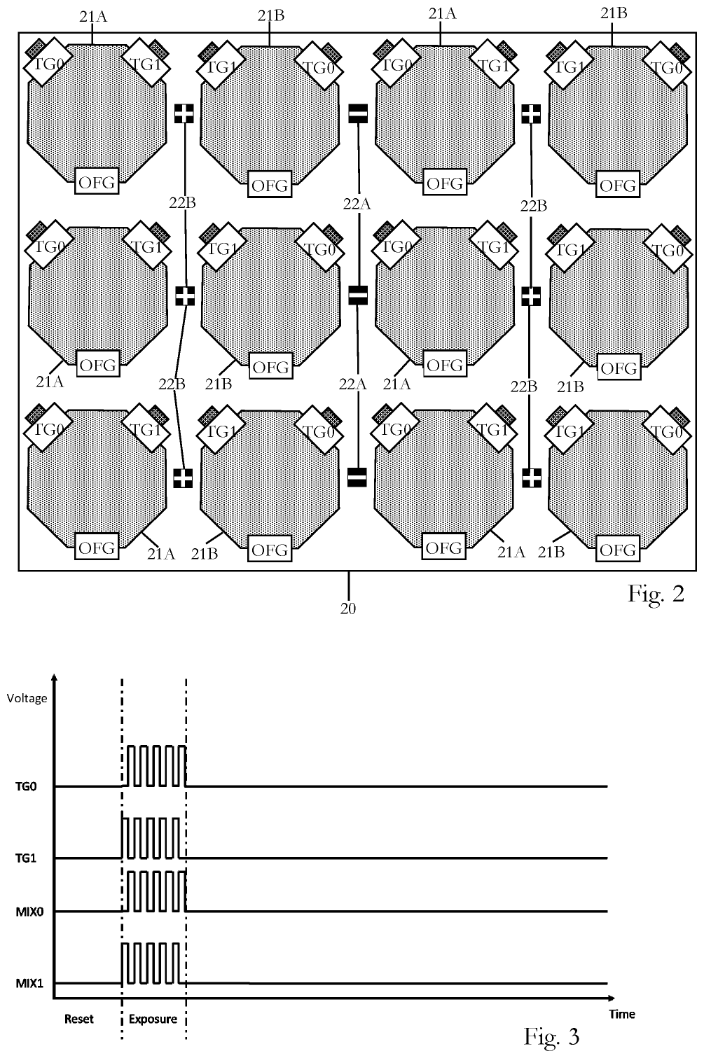

FIG. 2 illustrates a first embodiment of a light detection portion 20, which may be implemented in the image sensor 6 of the ToF device of FIG. 1, wherein the light detection portion 20 is illustrated in a top view.

The light detection portion 20 has multiple photo conversion portions 21, which are also referred to as pixels 21 in the following description.

Each of the pixels 21 has an overflow gate OFG and a first transfer gate TG0 and a second transfer gate TG1, wherein at each transfer gate TG0 and TG1 a floating diffusion FD portion is provided.

Each of the pixels 21 has a symmetrical shape having a cross section with eight sides and eight edges, i.e. an octagon shape.

In the first embodiment of FIG. 2, there are provided two types of pixels 21, a first type 21A and a second type 21B.

Each pixel 21A has a transfer gate TG0 on the upper left side and a transfer gate TG1 on the upper right side in FIG. 2, wherein each pixel 21B has a transfer gate TG1 on the upper left side and a transfer gate TG0 on the upper right side in FIG. 2. The OFG is located on the bottom side for pixels 21A and 21B.

The pixels 21 are arranged in an array in rows in columns, wherein in the first column pixels 21A are provided, in the second column pixels 21B, in the third column pixels 21A, and in the fourth column pixels 21B. For the rows, this means that every row starts with a pixel 21A followed by a pixel 21B, followed by a pixel 21A and the last is a pixel 21B, and that the pixels are arranged on straight (parallel) lines in rows and columns, as it is generally known for a pixel array.

With this arrangement, each of the TG0 of two neighboring pixels are arranged opposite to each other and each of the TG1 of two neighboring pixels are arranged opposite to each other.

For instance, the TG1 of the pixel 21A (on the right side of the pixel 21A) is next to the TG1 of the neighboring pixel 21B (on the left side of the pixel 21B), wherein the TG0 of the pixel 21B (on the right side) is next to the right neighboring pixel 21A, etc.

Moreover, between each two neighboring pixel in a row a biasing voltage portion 22 is provided, wherein in this embodiment, between two first transfer gates TG0 a first biasing voltage portion 22A is provided and between two second transfer gates TG0 a second biasing voltage portion 22B is provided, since the first biasing voltage portions 22A are associated with the TG0 transfer gates and the second biasing voltage portions 22B are associated with the TG1 transfer gates. The first 22A and the second 22B biasing voltage portions are arranged on a line which intersects the pixels 21A and 21B of a row in a middle area (through the center/symmetry line) of the pixels.

The biasing voltage portions 22 are provided by implanting (e.g. p-doping) a substrate of the light detection portion 20, and, they are biased synchronous with their associated transfer gates as will be discussed under reference if FIG. 3.

FIG. 3 illustrates a timing diagram for driving the TG0 and TG1 gates and the first and second biasing voltage portions 22A and 22B, wherein in FIG. 3 the first biasing voltage portions are referred to as “MIX0” and the second biasing voltage portions are referred to as “MIX1”.

The timing diagram of FIG. 3 illustrates the time on the abscissa and the voltages of different driving signals for TG0, TG1, MIX0 and MIX1 on the ordinate.

Moreover, FIG. 3 shows two time intervals, namely a “Reset” time interval during which the pixels 21A and 21B are reset and an “Exposure” time interval during which the light source is driven and reflected light is detected by the pixels 21A and 21B.

As can be taken from FIG. 3, when the driving signal is applied to the first transfer gates TG0 also the first biasing voltage portions 22A “MIX0” are driven and when the driving signal is applied to the second transfer gates TG1 also the second biasing voltage portions 22B “MIX1” are driven.

FIG. 2 illustrates a situation where the second transfer gate TG1 is in a high state (i.e. having a high electric potential) and, thus, the second biasing voltage portions 22B (MTX1) are applied with a high biasing voltage, which is indicated with the “+”, whereas the first biasing voltage portions 22A (MIX0) are applied with a low biasing voltage (i.e. having a low electric potential), which is indicated with the “−”.

As can be taken from the timing diagram of FIG. 3, in the next situation, the TG0 would be driven, such that the first biasing voltage portions 22A (MIX0) will be biased with a high biasing voltage and the second biasing voltage portions 22B (MIX1) will be biased with a low biasing voltage.

Thereby, the driving of the first and second transfer gates TG0 and TG1 and the application of the biasing voltages to the associated first and second biasing voltage portions 22A and 22B, respectively, which are associated with the transfer gates TG0 and TG1, is synchronized (and alternates accordingly), such that the gradient of the electric field generated by applying the basing voltages to the first and the second biasing voltage portions 22A and 22B enhance the charge carrier transport to the associated transfer gate TG0 (associated with the first biasing voltage portions 22A) and TG1 (associated with the second biasing voltage portions 22B).

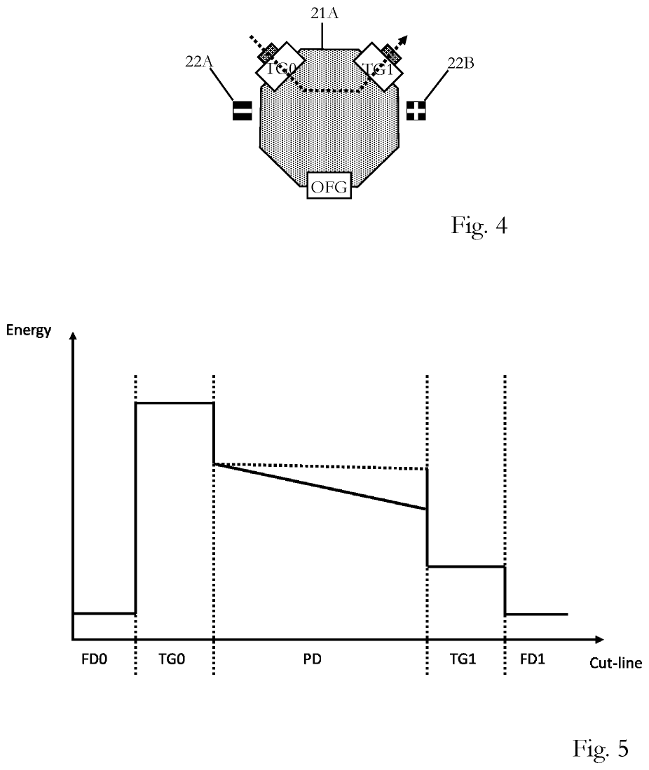

FIG. 4 illustrates one pixel 21A with a first biasing voltage portion 22A (“MIX0”) on the right side (which is associated with TG0) and a second biasing voltage portion 22B (“MIX1”) on the left side (which is associated with TG1). Moreover, a dotted line illustrates a path through the structure pixel 21A for illustrating different energy levels, as is shown in FIG. 5.

FIG. 5 shows the energy levels through the line explained under reference of FIG. 4 and the ordinate shows the energy and the abscissa the cut-line of FIG. 4, wherein in this example the level diagram for the TG1 high case is shown (i.e. where TG1 is at a high potential due to application of corresponding biasing voltage), wherein FIG. 5 illustrates the energy level on the ordinate. As mentioned, a high energy level means a low potential and vice versa.

It starts with a low energy level (high potential) in the floating diffusion FD0 at the transfer gate TG0, then a high energy level is present in the TG0 transfer gate region. In the inner of the pixel 21A, namely in the Photo-Diode (PD) region, the dotted line represents the PD energy level without the MIX0 and MIX1 and without applying the biasing voltages, wherein the regular line represents the PD energy with the added biasing voltages. As can be taken form FIG. 5, the electric energy decreases (i.e. the potential increases) within the pixel 21A when going from the first transfer gate TG0 to the second transfer gate TG1 which is at a high potential, i.e. low energy level. In the TG 1 region, the energy level is lower and in the FD1 region, the energy level is comparative to the FD0 energy level.

In the case of the TG0 high state, the electric energy will have the opposite decreasing, i.e. it will decrease from the second transfer gate TG1 to the first transfer gate TG0 (and, thus, the potential will increase from the second transfer gate TG1 to the first transfer gate TG0).

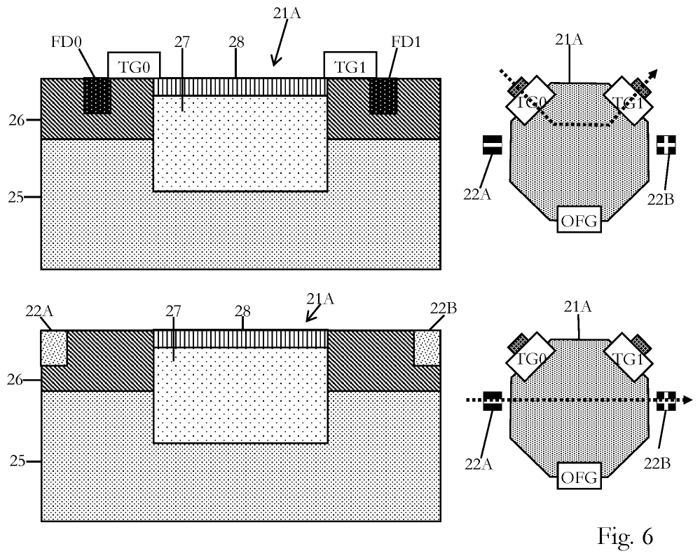

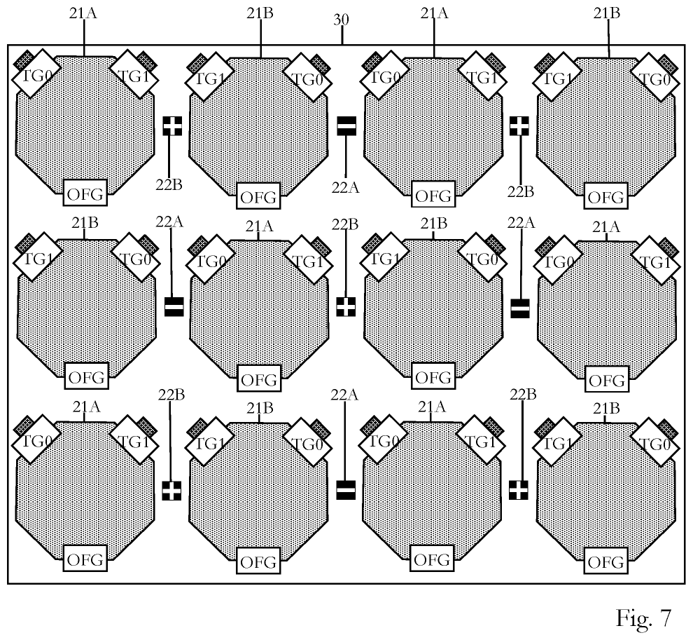

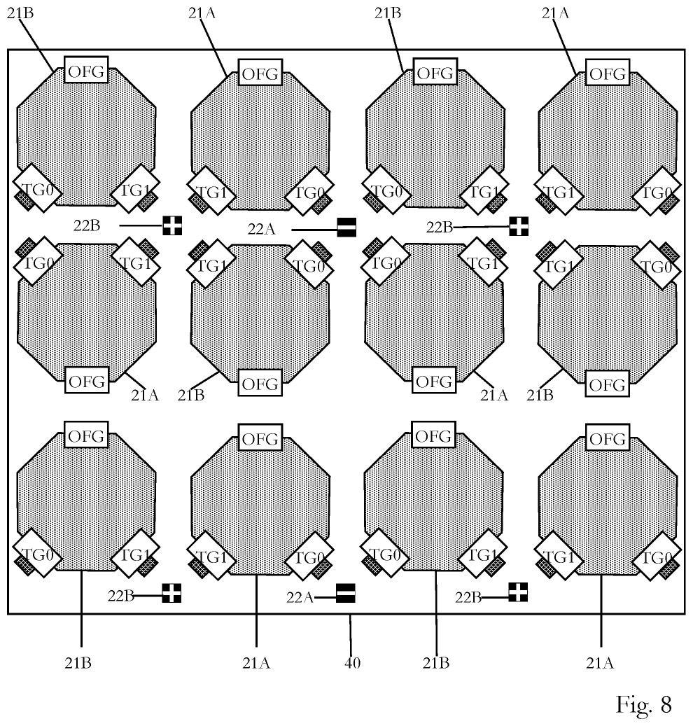

The structure of the pixels is exemplary explained under reference of FIG. 6 illustrating on the upper side a cross section through the pixel 21A, which is defined by the dotted line through the pixel 21A depicted on the upper right side, and on a lower side FIG. 6 illustrates another cross section through the pixel 21A, as defined by the dotted line through the pixel 21A as depicted on the lower right side.

The pixel 21A has a substrate portion 25, which is in this embodiment a p⁻ semiconductor substrate. An upper region 26 is heavier p-doped an in this region, the floating diffusion FD0 and FD1 are implanted. Moreover, in a middle region, the photo conversion portion or photodiode portion 27 is provided which is n-type doped, wherein on the top of the portion 27 a heavy p-doped layer 28 is provided. The transfer gates TG0 and TG1 are provided on top of the p-doped portion 26 and are such configured that the interconnect the n-type region of the photo conversion portion to the floating diffusion portions FD0 and FD1, respectively. Electrons, which are generated by the photo conversion portion 27, are collected in the n-type region (upper region of portion 27) and are then transferred under the TG0 and TG1 to FD0 and FD1, respectively.

The substrate portion 25 can also an n substrate. As mentioned, the region 26 is “heavier p-doped” in this embodiment. The FD0/1 region is very heavily n-doped (n+) in this embodiment. The MIX-regions (22A and 22B) are be very heavy p-type doped, i.e. p+ implanted, in this embodiment.

As can be taken from the cross section on the lower side of FIG. 6. The first biasing voltage portion 22A is provided in a predefined distance to the photo conversion portion 27 on the left side in FIG. 6, and the second biasing voltage portion 22B is provided in a predefined distance to the photo conversion portion 27 on the right side in FIG. 6, wherein the predefined distance for the first and the second biasing voltage portions 22A and 22B is equal (without limiting the present disclosure in that regard).

In the following, several different embodiments how light detection portions are discussed, wherein the general structure of the pixels (basically) and the method for controlling them corresponds to the pixel as discussed under reference of FIGS. 2 to 6.

FIG. 7 illustrates an embodiment of a light detection portion 30, wherein a plurality of pixels 21A and 21B are provided, as discussed under reference of FIGS. 2 to 6. However, in contrast to FIG. 2, the pixels 21A and 21B are alternately arranged in the rows and in the columns.

Hence, the first row starts with pixel 21A on the left side, followed by pixel 21B, followed by 21A, followed by 21B, etc.

The first column starts with pixel 21A on the left side, followed by pixel 21B below, followed by pixel 21A below, etc. (from left to right).

The second row starts with pixel 21B, followed by pixel 21A, followed by pixel 21B, followed by pixel 21A, etc. (from left to right).

In other words, in each row and in each column a pixel 21A is followed by a pixel 21B and vice versa.

Hence, also the first 22A and second 22B biasing voltage portions are arranged in an alternating manner, wherein, as also discussed under reference of FIG. 2, between two (first) transfer gates TG0 of neighboring pixels 21A and 21B the first biasing voltage portion 22A is arranged and between two (second) transfer gates TG1 the second biasing voltage portion 22B is arranged, such that neighboring or adjacent first transfer gates TG0 share a common first biasing voltage portion 22A and neighboring or adjacent second transfer gates TG1 share a common second biasing voltage portion 22B.

Consequently, as illustrated in FIG. 7, in a state where the TG1 is in the high state, the second biasing voltage portions 22B are biased with a high biasing voltage and, thus, are indicated with a “+” and the first biasing voltage portions 22A are biased with a low biasing voltage and, thus, are indicated with a “−”.

When the TG0 is in the high state, the applied biasing are reversed such that the first biasing voltage portions 22A are biased with a high biasing voltage and the second biasing voltage portions 22B are biased with a low biasing voltage.

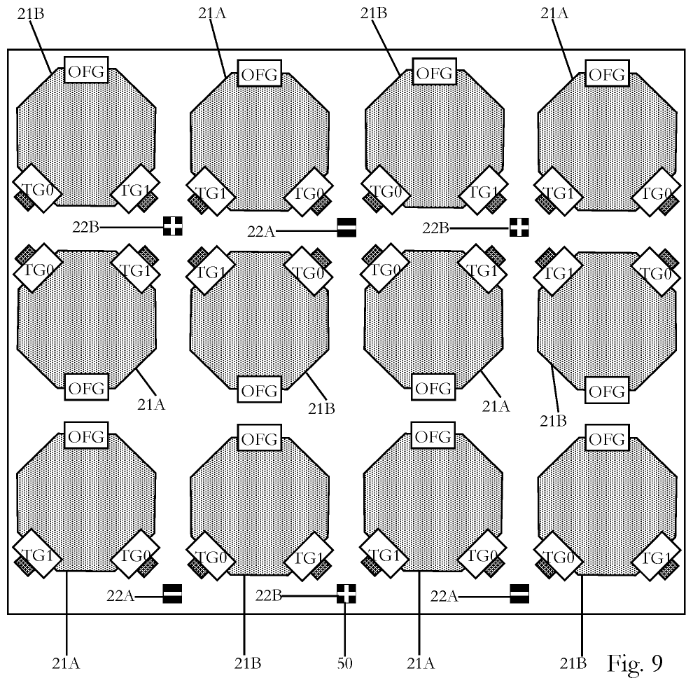

FIG. 8 illustrates an embodiment of a light detection portion 40, wherein a plurality of pixels 21A and 21B are alternating provided, as discussed under reference of FIGS. 2 to 6. However, in this embodiment, in the first and third row, the pixels are arranged with a rotation angle of 180° (and the first and third row are identical).

The first row has alternating pixels 21B and 21A (rotated by 180°) and it starts with a pixel 21B, followed by a pixel 21A, followed by a pixel 21B, followed by a pixel 21A.

The second row corresponds to the first row of FIG. 7 has alternating pixels 21A and 21B, and it starts with a pixel 21A, followed by a pixel 21B, followed by a pixel 21A, followed by a pixel 21B.

As the pixels 21A and 21B of the first row are rotated by 180°, the transfer gates TG0 and TG1 of the pixels of the first row and the second (and, similarly, of the third row and a fourth row, etc.), are such arranged that they are opposite to each other.

Hence, the second transfer gate TG1 of the first pixel 21B of the first row, the second transfer gate TG1 of the second pixel 21A of the first row, the second transfer gate TG1 of the first pixel 21A of the second row and the second transfer gate TG1 of the second pixel 21B of the second row face to each other and surround a common region, wherein a second biasing voltage portion 22B is arranged in the center of the common region, such that it is shared by the four surrounding second transfer gates TG1.

The first 22A and second 22B biasing voltage portions are arranged alternating in the center of the common region surrounded by the associated transfer gates of the four neighboring pixels, which surround the common region.

In FIG. 8, the first transfer gate TG0 of the second pixel 21A of the first row, the first transfer gate TG0 of the third pixel 21B of the first row, the first transfer gate of the second pixel 21B of the second row, and the first transfer gate TG0 of the third pixel 21A of the second row surround a common region, wherein in the center of this region a first biasing voltage portion 22A is arranged.

In the next common region surrounded by TG1 (second) transfer gates of the third and fourth pixel of the first and second row, a second biasing voltage portion 22B is arranged.

FIG. 8 illustrates the light detection portion 40 in a state, wherein the first transfer gates TG1 are high, and, thus, the second voltage portions 22B are biased with a high biasing voltage “+” and the first voltage portions 22A are biased with a low biasing voltage “−”.

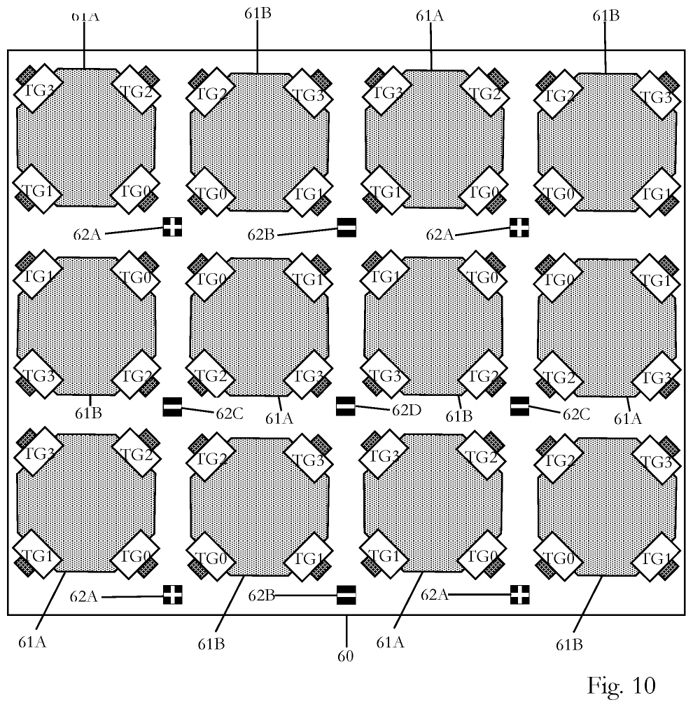

FIG. 9 illustrates a light detection portion 50, which basically corresponds to the light detection portion 40 of FIG. 8, wherein in the light detection portion 50 the first and the second row are identical to the first and the second rows of the light detection portion 40 of FIG. 8.

The third row (and, thus, a fourth row, which is not illustrated), however, differs from the third row of the light detection portion 40 of FIG. 8, since the third row of the light detection portion 50 of FIG. 9 does not correspond to the first row, but starts with a pixel 21A, followed by a pixel 21B, followed by a pixel 21A, followed by a pixel 21B (all rotated by 180°).

This shows that also the odd rows may have an alternating pattern of arrangement of the pixels 21A and 21B in some embodiments and, thus, also the first and second biasing voltage portions 22A and 22B may have an alternating pattern on a row-by-row basis.

Of course, the alternating patterns discussed above are not limited to the given examples, but other patterns may be implemented, and, of course, the patterns may also be applied, for example, on a column-by-column basis, etc.

Although in the embodiments discussed above the pixels only have two transfer gates (or two demodulation portions), the present invention is not limited in that regard, but the pixels may have any other number of transfer gates (demodulation portions).

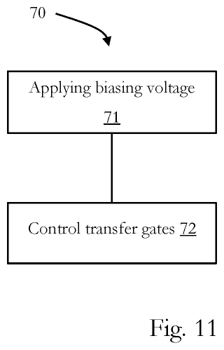

FIG. 10 illustrates a light detection portion 60 having multiple pixels 61 arranged in an array, wherein the pixels 61 each have four transfer gates TG0, TG1, TG2 and TG3 arranged on the upper left, upper right, lower left and lower right corners, wherein each the transfer gates TG0 are opposite to TG3 and the transfer gates TG1 are opposite to TG2.

There are two types of pixels 61 in the light detection portion 60, namely first type pixels 61A, which have the transfer gates in the order TG0, TG1, TG3 and TG2 (starting at TG0 and in a clockwise manner) and second type pixels 61B which have the transfer gates in the order TG0, TG2, TG3, and TG1 (starting at TG0 and in a clockwise manner).

The pixels 61 are arranged in an array, i.e. in rows and columns, wherein in FIG. 10 only three rows and four columns are depicted.

The first type pixels 61A and the second type pixels 61B are arranged alternating in the rows and in the columns, wherein the first and third row are identical (i.e. the odd rows are identical).

The first row starts with a first type pixel 61A, wherein the pixel 61A is such arranged that the transfer gate TG3 is at the upper left (then TG2, TG0, and TG1 in a clockwise manner). On the next right side of the first type pixel 61A at the first pixel location in the first row, a pixel 61B is arranged, which is such arranged that the transfer gate TG2 is at the upper left (then TG3, TG1, TG0 in a clockwise manner), such that the TG2 and the TG0 transfer gates of the first 61A and the second pixel 61B face to each other. At next a pixel 61A is arranged in the first row having the same orientation as the first pixel 61A (such that the transfer gates TG3 and TG1 of the second 61B and the third 61A pixel face to each other), followed by a pixel 61B having the same orientation as the second pixel 61B of the first row.

In the second row also first type pixels 61A and second type pixels 61B are arranged in an alternating manner, however, the second row starts with a second type pixel 61B and the first type pixels 61A and the second type pixels 61B of the second row are rotated by 180° compared to the first row.

Hence, in the second row the first type pixel 61A (at a second pixel location in the second row) is such arranged that the transfer gate TG0 is at the upper left (then TG1, TG3, and TG2 in a clockwise manner), followed by a second type pixel 61B (at a third pixel location in the second row) which is such arranged that the transfer gate TG1 is at the upper left (then TG0, TG2, and TG3 in a clockwise manner), such that the transfer gates TG0 and TG2 of the first type pixel 61A and the second type pixel 61B face to each other between the left side of the first type pixels 61A and the right side of the second type pixels 16B (and the transfer gates TG1 and TG3 on the left side of the second type pixels 61B face to the transfer gates TG1 and TG3 on the right side of the first type pixels 61A). The second type pixel 61B at the third pixel location of the second row corresponds to the second type pixel 61B at the first pixel location of the second row and the pixel 61A at the fourth pixel location of the second row corresponds to the pixel 61A at the second pixel location of the second row.

With this arrangement, the first type pixel 61A at the first pixel location and the second type pixel 61B at the second pixel location of the first row and the first type pixel 61A at the second pixel location and the second type pixel 61B at the first pixel location of the second row are such arranged that their TG0 transfer gates surround a common region, wherein in the center of this common region an associated first biasing voltage portion 62A is arranged.

The second type pixel 61B at the second pixel location of the first row and the first type pixel 61A at the third pixel location of the first row and the first type pixel 61A at the second pixel location of the second row and the second type pixel 61B at the third pixel location of the second row are such arranged that their TG1 transfer gates surround a common region, wherein in the center of this common region an associated second biasing voltage portion 62B is arranged.

The TG0 gates of the pixels (61A, 61B) at the third pixel location and of the pixels (61B, 61A) at the fourth pixel location of the first and second rows surround a common region, wherein in the center of this common region an associated first biasing voltage portion 62A is arranged.

Hence, the pixels 61A and 61B of the first and the second row are such arranged that they surround in an alternating manner common regions with the TG0 and the TG1 transfer gates, respectively, wherein the TG0 surrounded region includes the first biasing voltage portion 62A and the TG1 surrounded region includes the second biasing voltage portion 62B.

Between the second and the third row, the pixels 61A and 61B of the second and the third row are such arranged that they surround in an alternating manner a common region with the TG2 transfer gates and the TG3 transfer gates, respectively, as can be taken from FIG. 10.

The first type and second type pixels 61A, 61B at the first and second pixel locations of the second and third row are such arranged that their TG2 transfer gates surround a common region, wherein in the center of this region an associated third biasing voltage portion 62C is arranged.

The pixels 61A, 61B at the second and third pixel locations of the second and third row are such arranged that their TG3 transfer gates surround a common region, wherein in the center an associated fourth biasing voltage portion 62D is arranged.

The pixels 61A, 61B at the third and the fourth pixel locations of the second and third row are such arranged that their TG2 transfer gates surround a common region, wherein in the center an associated fourth biasing voltage portion 62C is arranged.

FIG. 10 illustrates a status of the light detection portion wherein the TG0 transfer gates are in a high state. Thus, the first biasing voltage portions 62A are biased with a high biasing voltage “+”, and the second, third and fourth biasing voltage portions 62B, 62C, and 62D are biased with a low biasing voltage “−”.

If the second transfer gates TG1 are high, the second voltage portion 62B, which are associated with the second transfer gates 62B are high, and the remaining are low, etc.

For simplicity reasons, in this embodiment, the OFG was not added, but in other embodiments, OFG gates are also provided for multi-transfer gate light detection portions.

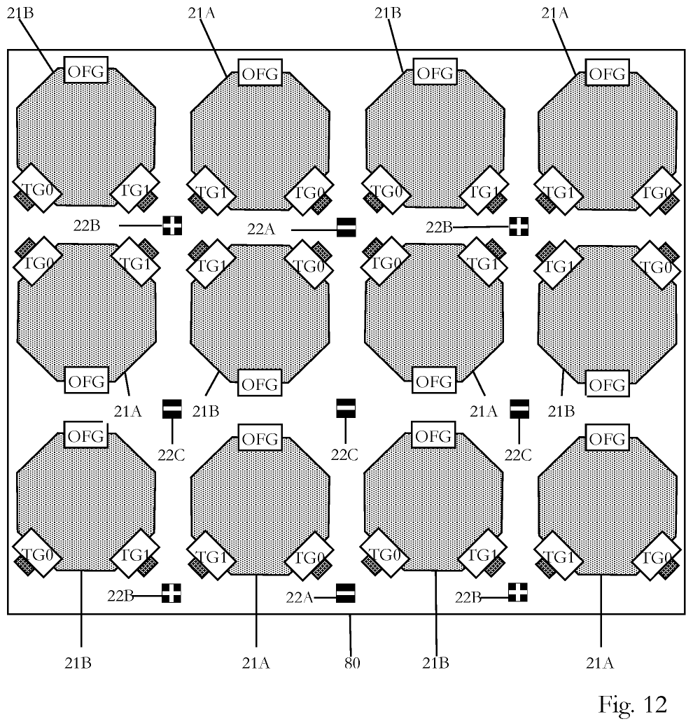

In the following, a method 70 for controlling a time-of-flight device as discussed herein is explained under reference of FIG. 11 showing a flowchart of method 70.

At 71, a biasing voltage is applied by applying a voltage to the first and the second biasing voltage portions (or also to the third and fourth biasing voltage portions in the case of the embodiment of FIG. 10), as discussed herein.

At 72, the first and the second transfer gate (and, e.g., the third and fourth transfer gates) are controlled consecutively for performing demodulation of a detected light signal, as discussed herein.

FIG. 12 illustrates a variant of the embodiment of FIG. 8, wherein in the embodiment of FIG. 12 a light detection portion 80 is depicted which generally has the same structure and arrangement of pixels 21A and 21B as the light detection portion 40 of FIG. 8, and which also has the same arrangement of first 22A and second 22B biasing voltage portions as the light detection portion 40 of FIG. 8.

The only difference between the embodiment of FIG. 8 and of FIG. 12 is that in the light detection portion 80 of FIG. 12 additionally an MIXR (MIX_reset) implant biasing voltage portion 22C is provided between the second and third pixel row, wherein each of the biasing voltage portions 22C is surrounded by four pixels. In other words, each of the three biasing voltage portions 22C depicted in FIG. 12 is arranged in a center region which is symmetrically surrounded by pixels 21A and 21B of the second and third row which are such arranged that their side, which is opposite to the TG0 side, faces in the direction of the biasing voltage portion 22C in the center.

In this embodiment, each of the biasing voltage portion implants 22C is biased to a low voltage during exposure, when the TG0 and TG1 are being modulated.

Furthermore, the biasing voltage portion 22C may also allow to create an electric field in the direction towards the TG1 of the neighboring pixels 21A and 21B.

Additionally, the biasing voltage portion 22C can also be biased at a high voltage during a read-out period (when the first and second biasing voltage portions 22A and 22B are low).

Hence, in some embodiments, the biasing voltage portions 22C may improve a reset functionality.

In some embodiments, also a design trade-off in the TG vs OFG functionality that is more favorable to TG is addressed, since the OFG functionality can be recovered by biasing the MIXR 22C at a high biasing voltage.

For example, in embodiments where the TGs are placed horizontally in the center of the PD, the biasing voltage portions 22C can also be used for improving/enhancing an electric field towards the first and second biasing voltage portions 22A and 22B (in particular, when the third biasing voltage portion 22C is further separated into a first MIXR0 and second MIXR1 which are each associated with the first and second biasing voltages 22A and 22B, respectively).

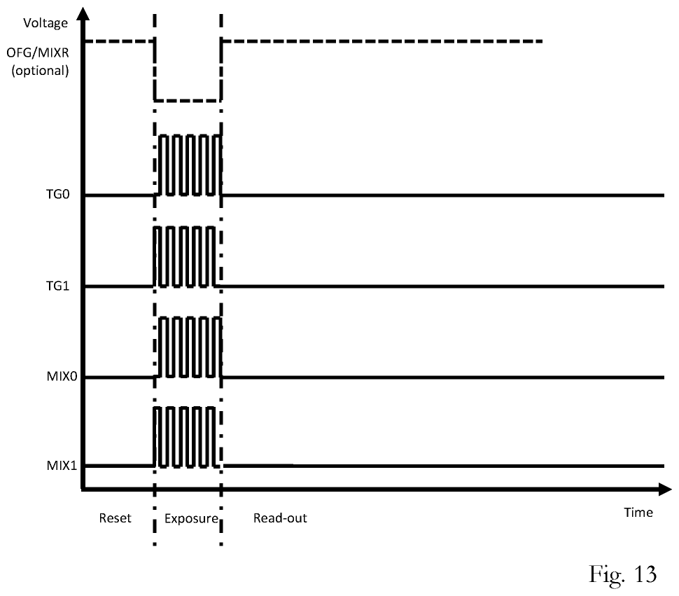

FIG. 13 illustrates a timing diagram (similar to FIG. 3) for driving the TG0 and TG1 gates and the first and second biasing voltage portions 22A and 22B of the light detection portion 80 of FIG. 12, wherein in FIG. 13 the first biasing voltage portions are referred to as “MIX0” and the second biasing voltage portions are referred to as “MIX1”.

The timing diagram of FIG. 13 illustrates the time on the abscissa and the voltages of different driving signals for TG0, TG1, MIX0 and MIX1 on the ordinate. Additionally, the (optional) voltage signals for the OFG and/or the MIXR biasing voltage portion 22C is illustrated.

FIG. 13 illustrates three time intervals, namely a “Reset” time interval during which the pixels 21A and 21B are reset, an “Exposure” time interval during which the light source is driven and reflected light is detected by the pixels 21A and 21B and a “read-out” time interval during which the electrons are read-out which have been generated by the PD during the exposure time interval.

As can be taken from FIG. 13, during the exposure time interval, when the driving signal is applied to the first transfer gates TG0 also the first biasing voltage portions 22A “MIX0” are driven and when the driving signal is applied to the second transfer gates TG1 also the second biasing voltage portions 22B “MIX1” are driven.

Moreover, the OFG/MIXR signal is high during the reset and also during the read-out time interval, but it is low during the exposure time interval, thereby causing the effects as discussed above.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) A time-of-flight device comprising:
a light detection portion including at least one photo conversion portion and a first biasing voltage portion and a second biasing voltage portion adjacent to the at least one photo conversion portion for generating an electric field across the at least one photo conversion portion.

(2) The time-of-flight device of (1), wherein the at least one photo conversion portion includes a first transfer gate and a second transfer gate.

(3) The time-of-flight device of (2), wherein the electric field applied to the first and second biasing voltage portions is aligned with the first gate and the second gate.

(4) The time-of-flight device of (3), wherein the electric field is such applied that electric carriers which are generated by photons incident into the at least one photo conversion portion are directed to the first gate and second gate, respectively.

(5) The time-of-flight device of anyone of (1) to (4), wherein the light detection portion includes multiple photo conversion portions, which are arranged in an array.

(6) The time-of-flight device of (5), wherein the first and the second biasing voltage portions are each located between adjacent photo conversion portions, such that the biasing voltage portions are on a middle line which intersects the photo conversion portions arranged on a line in a middle area.

(7) The time-of-flight device of (5), wherein the first and the second biasing voltage portions are each arranged adjacent to four photo conversion portions.

(8) The time-of-flight device of (7), further comprising a third and a fourth transfer gate.

(9) The time-of-flight device of (8), wherein the multiple conversion portions are such arranged that first transfer gates of four photo conversion portions are located next to each other, second gates of four photo conversion portions are located next to each other, third transfer gates of four photo conversion portion are located next to each other and fourth transfer gates of four photo conversion portions are located next to each other.

(10) The time-of-flight device of anyone of (1) to (9), wherein the at least one photo conversion portion is configured as a current assisted photonic demodulator.

(11) A method for controlling a time-of-flight device including a light detection portion including at least one photo conversion portion and a first biasing voltage portion and a second biasing voltage portion adjacent to the at least one photo conversion portion for generating an electric field across the at least one photo conversion portion, the method comprising:
applying the biasing voltage by applying a voltage to the first and the second biasing voltage portions.

(12) The method of (11), wherein the at least one photo conversion portion includes a first transfer gate and a second transfer gate and the method further comprises controlling the first and the second transfer gate consecutively for performing demodulation of a detected light signal.

(13) The method of (12), wherein the electric field applied to the first and second biasing voltage portions is aligned with the first gate and the second gate.

(14) The method of (13), wherein the electric field is such applied that electric carriers which are generated by photons incident into the at least one photo conversion portion are directed to the first gate and second gate, respectively.

(15) The method of anyone (11) to (14), wherein the light detection portion includes multiple photo conversion portions, which are arranged in an array.

(16) The method of (15), wherein the first and the second biasing voltage portions are each located between adjacent photo conversion portions, such that the biasing voltage portions are on a middle line which intersects the photo conversion portions arranged on a line in a middle area, wherein the application of the biasing voltage is adapted to driving of transfer gates of the two neighboring photo conversion portions.

(17) The method of (15), wherein the first and the second biasing voltage portions are each arranged adjacent to four photo conversion portions and wherein the application of the biasing voltage is adapted to driving of transfer gates of the four neighboring photo conversion portions.

(18) The method of (17), further comprising a third and a fourth transfer gate.

(19) The method of (18), wherein the multiple conversion portions are such arranged that first transfer gates of four photo conversion portions are located next to each other, second gates of four photo conversion portions are located next to each other, third transfer gates of four photo conversion portion are located next to each other and fourth transfer gates of four photo conversion portions are located next to each other, wherein the application of the biasing voltage is adapted to driving of the first to fourth transfer gates of the four neighboring photo conversion portions.

(20) The method of anyone of (11) to (19), wherein the at least one photo conversion portion is configured as a current assisted photonic demodulator.

(21) A computer program comprising program code causing a computer to perform the method according to anyone of (11) to (20), when being carried out on a computer.

(22) A non-transitory computer-readable recording medium that stores therein a computer program product, which, when executed by a processor, causes the method according to anyone of (11) to (20) to be performed.

1. A time-of-flight device comprising:
a light detection portion including at least one photo conversion portion and a first biasing voltage portion and a second biasing voltage portion adjacent to the at least one photo conversion portion for generating an electric field across the at least one photo conversion portion.

2. The time-of-flight device of claim 1, wherein the at least one photo conversion portion includes a first transfer gate and a second transfer gate.

3. The time-of-flight device of claim 2, wherein the electric field applied to the first and second biasing voltage portions is aligned with the first gate and the second gate.

4. The time-of-flight device of claim 3, wherein the electric field is such applied that electric carriers which are generated by photons incident into the at least one photo conversion portion are directed to the first gate and second gate, respectively.

5. The time-of-flight device of claim 1, wherein the light detection portion includes multiple photo conversion portions, which are arranged in an array.

6. The time-of-flight device of claim 5, wherein the first and the second biasing voltage portions are each located between adjacent photo conversion portions, such that the biasing voltage portions are on a middle line which intersects the photo conversion portions arranged on a line in a middle area.

7. The time-of-flight device of claim 5, wherein the first and the second biasing voltage portions are each arranged adjacent to four photo conversion portions.

8. The time-of-flight device of claim 7, further comprising a third and a fourth transfer gate.

9. The time-of-flight device of claim 8, wherein the multiple conversion portions are such arranged that first transfer gates of four photo conversion portions are located next to each other, second gates of four photo conversion portions are located next to each other, third transfer gates of four photo conversion portion are located next to each other and fourth transfer gates of four photo conversion portions are located next to each other.

10. The time-of-flight device of claim 1, wherein the at least one photo conversion portion is configured as a current assisted photonic demodulator.

11. A method for controlling a time-of-flight device including a light detection portion including at least one photo conversion portion and a first biasing voltage portion and a second biasing voltage portion adjacent to the at least one photo conversion portion for generating an electric field across the at least one photo conversion portion, the method comprising:
applying the biasing voltage by applying a voltage to the first and the second biasing voltage portions.

12. The method of claim 11, wherein the at least one photo conversion portion includes a first transfer gate and a second transfer gate and the method further comprises controlling the first and the second transfer gate consecutively for performing demodulation of a detected light signal.

13. The method of claim 12, wherein the electric field applied to the first and second biasing voltage portions is aligned with the first gate and the second gate.

14. The method of claim 13, wherein the electric field is such applied that electric carriers which are generated by photons incident into the at least one photo conversion portion are directed to the first gate and second gate, respectively.

15. The method of claim 11, wherein the light detection portion includes multiple photo conversion portions, which are arranged in an array.

16. The method of claim 15, wherein the first and the second biasing voltage portions are each located between adjacent photo conversion portions, such that the biasing voltage portions are on a middle line which intersects the photo conversion portions arranged on a line in a middle area, wherein the application of the biasing voltage is adapted to driving of transfer gates of the two neighboring photo conversion portions.

17. The method of claim 15, wherein the first and the second biasing voltage portions are each arranged adjacent to four photo conversion portions and wherein the application of the biasing voltage is adapted to driving of transfer gates of the four neighboring photo conversion portions.

18. The method of claim 17, further comprising a third and a fourth transfer gate.

19. The method of claim 18, wherein the multiple conversion portions are such arranged that first transfer gates of four photo conversion portions are located next to each other, second gates of four photo conversion portions are located next to each other, third transfer gates of four photo conversion portion are located next to each other and fourth transfer gates of four photo conversion portions are located next to each other, wherein the application of the biasing voltage is adapted to driving of the first to fourth transfer gates of the four neighboring photo conversion portions.

20. The method of claim 11, wherein the at least one photo conversion portion is configured as a current assisted photonic demodulator.
